(19) United States
(12) Patent Application Publication
(10) Pub. No.: US 2005/0249842 A1
(43) Pub. Date: Nov. 10, 2005

(54) Ingredient pakaging

(76) Inventors: Jill M. Abrahamsen, Winchester, MA (US); Robert M. Abrahamsen, Winchester, MA (US)

Correspondence Address: Jill M. Abrahamsen, 7 Ainsworth Road, Winchester, MA, 01890, US

(21) Appl. No.: 10/841,399

(22) Filed: May 8, 2004

(51) Int. Cl. A23L 1/00

(52) U.S. Cl. 426/87

(57) ABSTRACT

A quantity of packed brown sugar is disposed in a wrapper which has a plurality of markings on it that correspond to respective volumes of the packed brown sugar. A user is thus able to separate a desired volume of packed brown sugar from the remainder of the quantity of packed brown sugar by cutting the quantity of packed brown sugar at a location indicated by the marking on the wrapper that corresponds to the desired volume of packed brown sugar. In another embodiment, a package includes a plurality of individual containers each containing a pre-measured volume of a single baking ingredient, which pre-measured volume is greater than or equal to one-quarter cup and less than or equal to one cup.

### BACKGROUND

Brown sugar presently is sold only in cartons or bags of a particular size, e.g., one pound. When a recipe calls for brown sugar, it typically will require a certain volume (e.g., one cup) of “packed” brown sugar, i.e., brown sugar that has been tightly compressed. To measure such a volume of packed brown sugar, unpacked brown sugar is typically scooped or poured from a carton, bag, or other container into a measuring utensil, e.g., a measuring cup, and is then packed into such a utensil by pressing down on the brown sugar using a spoon or the like.

Other baking ingredients such as flour, granulated sugar, salt, baking powder, baking soda, etc., also are generally sold in bulk quantities. For instance, granulated sugar and flour are typically sold in five-pound bags. When smaller quantities of such substances are desired, it is necessary to use measuring utensils, e.g., measuring cups, tablespoons, teaspoons, etc., to separate the desired quantity from the remainder. It therefore becomes necessary to wash such measuring utensils after using them.

### SUMMARY OF THE INVENTION

According to one aspect of the present invention, a parcel comprises a quantity of packed brown sugar, and a wrapper. The wrapper is disposed about the quantity of packed brown sugar and has a plurality of markings on it that correspond to respective volumes of packed brown sugar included in the quantity of packed brown sugar. A user is thus able to separate a desired volume of packed brown sugar from the remainder of the quantity of packed brown sugar by cutting the quantity of packed brown sugar at a location indicated by the marking on the wrapper that corresponds to the desired volume of packed brown sugar.

According to another aspect of the invention, a method for measuring brown sugar comprises cutting a quantity of packed brown sugar at a location indicated by one of a plurality of markings corresponding to respective volumes of the packed brown sugar.

According to another aspect, a method for packaging brown sugar involves applying a plurality of markings to a packaging material associated with a quantity of packed brown sugar that correspond to respective volumes of packed brown sugar included in the quantity of packed brown sugar.

According to another aspect of the invention, a package includes a plurality of individual containers each containing a pre-measured volume of a single baking ingredient, each such pre-measured volume being greater than or equal to one-quarter cup and less than or equal to one cup.

### BRIEF DESCRIPTION OF THE DRAWINGS

FIG. 1 shows a perspective view of a parcel for brown sugar that embodies various aspects of the present invention;

FIG. 2 illustrates an example of a wrapper that may be included in the parcel shown in FIG. 1; and

FIG. 3 shows an example of how multiple individual containers containing pre-measured quantities of ingredients may be disposed in a package.

### DETAILED DESCRIPTION OF THE INVENTION

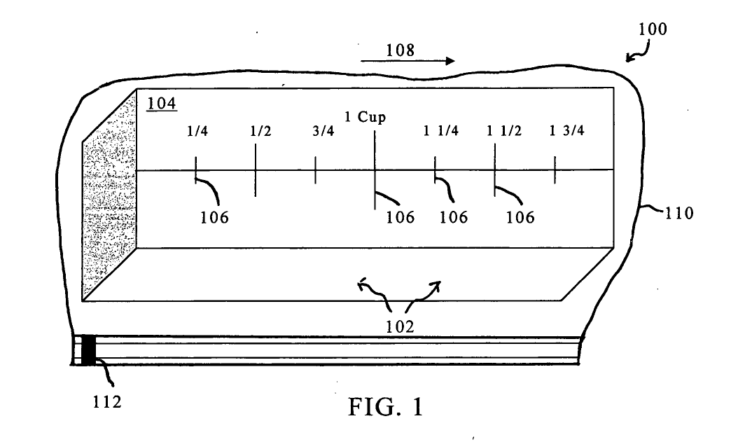

A brown sugar parcel embodying several aspects of the invention is shown in FIG. 1. As shown, a parcel 100 of brown sugar may comprise a quantity of brown sugar 102 that has been packed into a particular shape having a known volume, and may have a wrapper 104 disposed on it that can be readily cut by a knife or the like. The wrapper 104 has a plurality of markings 106 on it that correspond to respective volumes brown sugar 102 contained within the parcel 100.

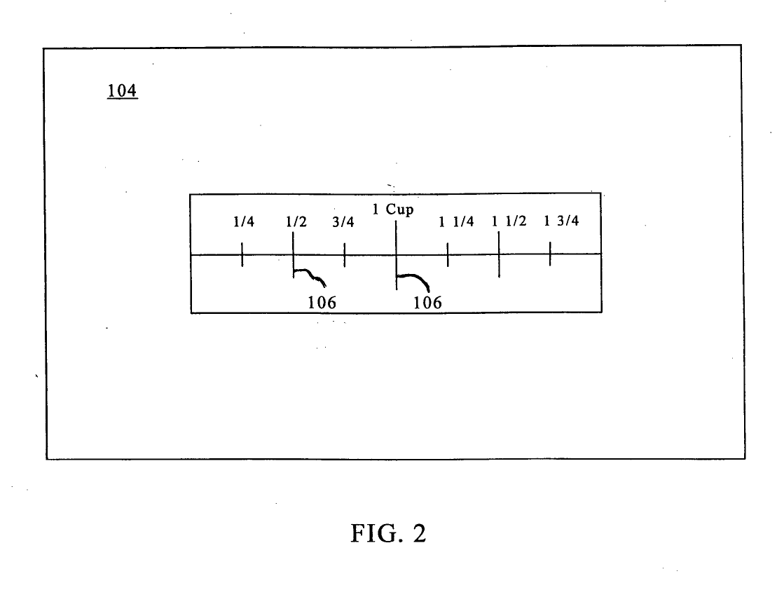

FIG. 2 shows how the wrapper 104 may appear when it is unfolded, e.g., before it is wrapped over the brown sugar 102 or after it has been removed therefrom. By cutting the parcel 100 where indicated by one of the markings 106, a corresponding quantity of the brown sugar 102 may be separated from the remainder.

In the example shown, the brown sugar 102 has been packed into a rectangular block that occupies a volume of two cups. Larger or smaller volumes may alternatively be used. As shown in FIG. 1, the block may extend generally in a first direction 108, and the wrapper 104 may have a plurality of lines 106 printed on at least one side of it that are perpendicular to the first direction 108. The cross-section of the block perpendicular to the first direction 108 may be, but need not be, square as shown in FIG. 1. Each adjacent pair of the lines 106 on the wrapper 104 may, for example, have one-fourth of a cup of brown sugar disposed therebetween. Lines of different lengths and/or weights may be used to indicate those markings that correspond to certain volumes of particular significance. In the example of FIG. 1, the quarter cup markings are relatively short and light weight, the one-half cup markings are slightly longer and darker than the quarter cup markings, and the one cup marking is the longest and the darkest of all of them. As shown, numbers may also be disposed adjacent some or all of the lines 106 to indicate the corresponding volume. In some embodiments, additional information may also be printed on the package to assist the user in separating the desired quantity from the remainder. For example, in embodiments in which one tablespoon of packed brown sugar is disposed between pairs of adjacent lines 106, information reflecting the number of tablespoons that are included in particular, larger volumes, e.g., in a quarter cup, one-half cup, and/or one cup, may be provided on the wrapper 104.

The wrapper 104 may be made of any of a number of suitable materials, and the invention is not limited to the use of any particular material. It is important only that the wrapper 104 be capable of being readily cut with a knife or the like in the manner discussed above. The wrapper 104 may, for example, be made of wax paper, metal foil, paper-backed foil, etc.

As shown in FIG. 1, the parcel 100 may include a hermetically sealed container disposed about the wrapper-covered block of brown sugar 102, so as to inhibit the brown sugar 102 from losing moisture and becoming stale. In some embodiments, the container may be configured so that it can be readily resealed after it has been opened. In this way, it is possible to use only a portion of the brown sugar 102 in the parcel 100, e.g., by cutting off the desired amount, and to preserve the remainder for later use. As shown in FIG. 1, the container 110 may, for example, comprise plastic bag 110 with a zipper 112 that can selectively establish an air tight seal, or may comprise a Tupperware-like container having a removable and re-sealable lid.

Multiple wrapped blocks of brown sugar 102 may be disposed in each container, or a separate container may be provided for each block. If desired, one or more containers may be packaged in a cardboard box or other package so as to resemble other brown sugar packages in the marketplace.

In some embodiments, brown sugar (or any other baking substance such as flour, granulated sugar, salt, baking soda, baking powder, etc.) may be sold in individual containers containing quantities of ingredients that are typically used for baking purposes. For example, individual hermetically-sealed bags or Tupperware-like containers of brown sugar may be provided, with each container having the equivalent of one-half cup of packed brown sugar in it. In such embodiments that include containers of brown sugar, the brown sugar would not need to remain packed within the hermetically-sealed containers. A single cardboard box or other package may include a plurality of such individual containers, e.g., ten bags, and may even be designed to resemble other ingredient packages currently sold in the marketplace. In some embodiments, the package for the individual containers may be a hermetically-sealed container for an added level of freshness preservation. Such a package may also be re-sealable. For instance, the package may be a plastic bag with a zipper or a Tupperware-like container with a re-sealable lid.

In some embodiments, multiple containers having different quantities of an ingredient may be included together in the same package. The individual containers may each have written indicia on them indicating the type and quantity of ingredient it contains. For example, a single package containing multiple individual containers of flour may include ten one-cup bags, ten one-half cup bags, and ten quarter cup bags of the ingredient. It should be appreciated that it is not necessary for some ingredients to be stored containers that are hermetically sealed. Thus, such ingredients may optionally be disposed in individual paper bags similar those commonly used for the larger quantities (e.g., five pound bags) of such ingredients, or other suitable non-hermetically sealed containers.

In some embodiments, e.g., in a cake baking kit, individual packs of different ingredients may be sold together in the same package. For example, such a kit may include, all within the same cardboard box, (A) ten one-cup bags and ten one-half cup bags of flour, (B) ten one cup bags and ten one-half cup bags of sugar, (C) ten tablespoon bags, ten one teaspoon bags and ten one-half teaspoon bags of salt, (D) ten tablespoon bags, ten one teaspoon bags and ten one-half teaspoon bags of baking soda, and (E) ten tablespoon bags, ten one teaspoon bags and ten one-half teaspoon bags of baking powder.

Examples of pre-measured quantities of baking substances that may advantageously be included in individual containers within a package include: (A) one-quarter, one-half or one cup quantities of flour, brown sugar, or granulated sugar, and (B) one quarter, one-half, or one teaspoon or tablespoon quantities of salt, baking powder, or baking soda. In some embodiments, one more of the containers included in a package may be hermetically re-sealable, e.g., a plastic bag with a zipper or a Tupperware-like container, so that the unused portion of the ingredient may be preserved after the container has been opened.

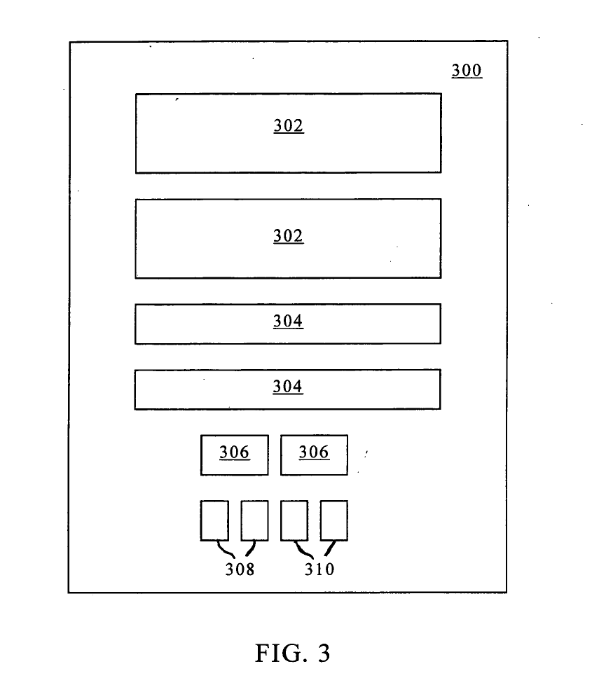

FIG. 3 illustrates how a package 300 may have disposed in it several individual ingredient containers, including, for example, two containers 302 each containing one cup of flour or granulated sugar or a quantity of brown sugar equal to one cup of packed brown sugar, two containers 304 each containing one-half cup of flour or granulated sugar or a quantity of brown sugar equal to one half-cup of packed brown sugar, two containers 306 each containing one-teaspoon of salt, two containers 308 each containing one-half teaspoon of baking soda, and two containers 310 each containing one-half teaspoon of baking powder. The containers 302-310 may, for example, be plastic bags, paper bags, and/or individual Tupperware-like containers disposed in a cardboard box 300.

In some embodiments, each container may be configured to be readily opened by hand. For example, bags may be used that are scored or that include perforations or lines of weakness that allow the bags to be readily ripped open. After the contents of an individual container has been emptied, that container may simply be thrown away.

Having thus described at least one illustrative embodiment of the invention, various alterations, modifications and improvements will readily occur to those skilled in the art. Such alterations, modifications and improvements are intended to be within the spirit and scope of the invention. Accordingly, the foregoing description is by way of example only and is not intended as limiting. The invention is limited only as defined in the following claims and the equivalents thereto.

1. A parcel, comprising:
a quantity of packed brown sugar; and
a wrapper disposed about the quantity of packed brown sugar, the wrapper having a plurality of markings thereon that correspond to respective volumes of packed brown sugar included in the quantity of packed brown sugar, thereby enabling a user to separate a desired volume of packed brown sugar from the remainder of the quantity of packed brown sugar by cutting the quantity of packed brown sugar at a location indicated by a marking on the wrapper that corresponds to the desired volume of packed brown sugar.

2. The parcel of claim 1, further comprising a hermetically sealed container in which the quantity of packed brown sugar is disposed.

3. The parcel of claim 2, wherein the container is configured and arranged to be selectively opened and resealed.

4. The parcel of claim 1, wherein the markings comprise a plurality of parallel lines on the wrapper.

5. The parcel of claim 4, wherein:
the quantity of packed brown sugar is in the shape of a rectangular block that extends in a first direction; and
the plurality of lines are oriented perpendicular to the first direction.

6. The parcel of claim 4, wherein a quarter of a cup of packed brown sugar is located between each pair of the plurality of parallel lines.

7. The parcel of claim 6, wherein the quantity of packed brown sugar comprises two cups of packed brown sugar.

8. The parcel of claim 1, wherein the quantity of packed brown sugar comprises two cups of packed brown sugar.

9. The parcel of claim 1, wherein the quantity of packed brown sugar is in the shape of a rectangular block.

10. A method for measuring brown sugar, comprising a step of:
(a) cutting a quantity of packed brown sugar at a location indicated by one of a plurality of markings corresponding to respective volumes of the packed brown sugar.

11. The method of claim 10, wherein the step (a) comprises using a knife to cut the quantity of packed brown sugar at the location indicated by the one of the plurality of markings.

12. The method of claim 10, wherein the step (a) comprises cutting the quantity of packed brown sugar along one of a plurality of lines marked on a wrapper in which the quantity of packed brown sugar is disposed.

13. The method of claim 12, wherein:
the quantity of packed brown sugar is in the shape of a rectangular block that extends in a first direction; and
the plurality of lines are oriented perpendicular to the first direction.

14. The method of claim 10, further comprising a step of opening a hermetically sealed container in which the quantity of packed brown sugar is disposed.

15. The method of claim 14, further comprising a step of hermetically sealing the container after performing the step (a).

16. A package of baking ingredients, comprising:
a package; and
a plurality of individual containers disposed within the package, each of the plurality of individual containers containing a pre-measured volume of a single baking ingredient, each such pre-measured volume being greater than or equal to one quarter cup and less than or equal to one cup.

17. The package of claim 16, wherein the single baking ingredient is flour.

18. The package of claim 16, wherein the single baking ingredient is granulated sugar.

19. The package of claim 16, wherein the single baking ingredient is packed brown sugar.

20. The package of claim 16, wherein at least two of the plurality of individual containers contain different baking ingredients.

21. The package of claim 16, wherein each of the at least two of the plurality of individual containers has indicia thereon that indicates the identity of the baking ingredient that is contained therein.

22. The package of claim 16, wherein at least two of the plurality of individual containers contain the same baking ingredient.

23. The package of claim 22, wherein the at least two of the plurality of individual containers contain different volumes of the same baking ingredient.

24. The package of claim 23, wherein each of the at least two of the plurality of individual containers has indicia thereon that indicates the pre-measured volume of the baking ingredient that is contained therein.

25. The package of claim 16, wherein at least two of the plurality of individual containers are individually hermetically sealed.

26. The package of claim 25, wherein the at least two of the plurality of individual containers are re-sealable so as to permit a hermetic seal to be reformed after either of the at least two of the plurality of individual containers has been opened.

27. The package of claim 16, wherein the package has disposed therein at least one additional individual container containing a pre-measured volume of a single baking ingredient that is less than one-quarter cup or greater than one cup.
